(19) United States
(12) Patent Application Publication
(10) Pub. No.: US 2022/0299645 A1
(43) Pub. Date: Sep. 22, 2022

(54) REMOTE VISUALIZATION APPARATUS COMPRISING A BORESCOPE AND METHODS OF USE THEREOF

(71) Applicant: Southwest Research Institute, San Antonio, TX (US)

(72) Inventors: Joseph Nathan MITCHELL, San Antonio, TX (US); Albert Joseph PARVIN, JR., San Antonio, TX (US)

(21) Appl. No.: 17/249,897

(22) Filed: Mar. 17, 2021

(51) Int. Cl. G01S 17/894; G02B 23/24; G02B 23/26; H04N 13/254; H04N 13/296

(52) U.S. Cl. CPC G01S 17/894; G02B 23/2469; G02B 23/2484; G02B 23/26; H04N 13/254; H04N 13/296

(57) ABSTRACT

A remote 3D measurement and visualization apparatus which comprises a borescope, comprising a shaft; a time-of-flight (TOF) depth camera having a plurality of pixels; an illumination source to emit illumination source light; wherein an illumination transmission portion of the shaft is operatively arranged to transmit the illumination source light distally along the shaft and emit the illumination source light from a distal end of the borescope to illuminate a target volume; wherein an image transmission portion of the shaft is operatively arranged to receive reflected illumination source light from the target volume and transmit the reflected illumination source light proximally along the shaft to the TOF depth camera; and wherein the TOF depth camera is operatively arranged to transmit intensity and phase data of the reflected illumination source light from the pixels to a processor and/or a computer to generate a digital, three-dimensional, spatial representation of the target volume.

### FIELD

The present disclosure relates to borescopes, methods of use and systems thereof, and, more particularly, such which make use of light detection and ranging, which may be referred to by the acronym LIDAR, for 3D visualization and measurement of a volume through a confined space access point.

### BACKGROUND

Characterization and inspection of industrial equipment, facilities and other structures must sometimes be carried out through an access point which may comprise a small port, a confined space, or a convoluted/tortious path, such as a pipe. In military applications, soldiers and other combatants must occasionally assess a space (e.g. room) prior to entry by inserting a probe under a door or through another small opening into the space to determine the layout of the space and/or if adversaries are present. These types of inspections can be carried out by a small diameter, visual borescope.

The borescope may contain a bundle of optical fibers that transmit an image of an inspection site, scene or other target area to an eyepiece. These borescopes may also provide an illumination source which provides illumination of the target area via one or more of the optical fibers in the bundle. However, the view through these borescopes can sometimes be difficult to interpret (e.g. distorted), particularly if there are no features present to provide a sense of scale and the low contrast of borescope images can mask objects or cause them to have an ambiguous relationship to their surroundings. In some applications, it may be important to be able to accurately measure the dimensions of what is being inspected or otherwise viewed for planning or verification. This cannot be readily done with a visual borescope.

One methodology useful for area measurement is LIDAR, which stands for either “Light Imaging Detection And Ranging” or “LIght and raDAR”. LIDAR is a remote-sensing technology for estimating distance/range/depth with use of an integrated illumination source, particularly a laser. More particularly, a laser beam emitted from the laser is used to illuminate a target volume, and the reflection of the laser light illumination in the target volume, such as from objects, is then detected and measured with a sensor, particularly a photodetector. The remote measurement principle may be referred to as time-of-flight (TOF).

To date, solid-state LIDAR has mostly been used in large area surveying/mapping, e.g. using aircraft, as well as obstacle avoidance and localization applications such as autonomous motor vehicles, unmanned aerial vehicles (UAVs), and in machine vision for industrial robotics. However, LIDAR has not been used through confined access points associated with use of a borescope.

### SUMMARY

A remote 3D measurement and visualization apparatus which comprises a borescope, comprising a light and image transmission shaft; a solid state, time-of-flight depth camera having a plurality of pixels; an illumination source to emit illumination source light; wherein the illumination source light is modulated or pulsed to generate a time-varying intensity suitable for the time-of-flight depth camera to measure distances within a target volume; wherein the shaft has a diameter suitable to enter the target volume through a confined (size-restricted) access point; wherein the shaft has an illumination transmission portion and an image transmission portion; wherein the illumination transmission portion of the shaft is operatively arranged to transmit the illumination source light from the illumination source distally along the shaft and emit the illumination source light from a distal end of the borescope to illuminate the target volume; wherein the image transmission portion of the shaft is operatively arranged to receive reflected illumination source light from the target volume and transmit the reflected illumination source light proximally along the shaft to the time-of-flight depth camera; and wherein the time-of-flight depth camera is operatively arranged to receive the reflected illumination source light from the image transmission portion of the shaft and to transmit intensity (amplitude) and phase data of the reflected illumination source light from the pixels to a processor and/or a computer to generate a digital, three-dimensional, spatial representation of the target volume.

In at least one embodiment, the borescope comprises a proximal control unit coupled to the shaft; and the proximal control unit comprises the time-of-flight depth camera.

In at least one embodiment, the borescope comprises a proximal control unit coupled to the shaft; and the proximal control unit comprises the illumination source.

In at least one embodiment, a camera coupling lens is disposed between a proximal end of the image transmission portion of the shaft and the time-of-flight depth camera; and the camera coupling lens images the reflected illumination source light transmitted from the image transmission portion of the shaft onto an image plane of the time-of-flight depth camera.

In at least one embodiment, an illumination source coupling lens is disposed between a proximal end of the illumination transmission portion of the shaft and the illumination source; and the illumination source coupling lens operatively couples the illumination source light from the illumination source to the illumination transmission portion of the shaft.

In at least one embodiment, the shaft is a flexible shaft; the illumination transmission portion of the shaft is provided by a first group of optical fibers; and the image transmission portion of the shaft is provided by a second group of optical fibers.

In at least one embodiment, the shaft is a rigid shaft; and at least one of the illumination transmission portion of the shaft and the image transmission portion of the shaft is provided by a rigid tubular light guide, respectively.

In at least one embodiment, the rigid tubular light guide comprises at least one rod lens.

In at least one embodiment, the rigid tubular light guide comprises at least one relay lens.

In at least one embodiment, the illumination source comprises a laser.

In at least one embodiment, the laser is a diode laser.

In at least one embodiment, the illumination source comprises one or more light emitting diodes.

In at least one embodiment, the image transmission portion of the shaft is provided by a group of optical fibers; and the group of optical fibers are arranged in a coherent array so that their relative positions remain fixed from one end to an opposing end of the group.

In at least one embodiment, the time-of-flight depth camera comprises an image or a focal plane having an array of the pixels; the image transmission portion of the shaft is provided by a group of optical fibers; each pixel of the array of the pixels is operatively coupled to one of the optical fibers in a one-to-one relationship; and a position of each of the optical fibers remains fixed relative to one another from a proximal end of each fiber to a distal end of each fiber, respectively.

In at least one embodiment, the diameter of the shaft is 1 mm to 25 mm.

In at least one embodiment, the diameter of the shaft is 8 mm or less.

A method of operating a remote 3D measurement and visualization apparatus which comprises obtaining the remote 3D measurement and visualization apparatus, wherein the remote visualization apparatus comprises a borescope, comprising a light and image transmission shaft; a solid state, time-of-flight depth camera having a plurality of pixels; an illumination source to emit illumination source light; wherein the illumination source light is modulated or pulsed to generate a time-varying intensity suitable for the time-of-flight depth camera to measure distances within a target volume; wherein the shaft has a diameter suitable to enter the target volume through an access point; wherein the shaft has an illumination transmission portion and an image transmission portion; wherein the illumination transmission portion of the shaft is operatively arranged to transmit the illumination source light from the illumination source distally along the shaft and emit the illumination source light from a distal end of the borescope to illuminate a target volume; wherein the image transmission portion of the shaft is operatively arranged to receive reflected illumination source light from the target volume and transmit the reflected illumination source light proximally along the shaft to the time-of-flight depth camera; and wherein the time-of-flight depth camera is operatively arranged to transmit intensity and phase data of the reflected illumination source light from the pixels to a processor and/or a computer to generate a digital, three-dimensional, spatial representation of the target volume; inserting the shaft of the borescope through an access point of a structure; and operating the remote visualization apparatus, including the borescope, to generate the digital, three-dimensional, spatial representation of a target volume within the structure.

In at least one embodiment, operating the remote visualization apparatus is performed as part of an inspection of the target volume.

### FIGURES

The above-mentioned and other features of this disclosure, and the manner of attaining them, will become more apparent and better understood by reference to the following description of embodiments described herein taken in conjunction with the accompanying drawings, wherein:

FIG. 1 is a perspective view of a remote visualization apparatus, comprising a borescope, according to the present disclosure;

FIG. 2 is a side view of portions of the remote visualization apparatus of FIG. 1; and

FIG. 3 is a perspective view of a rigid tubular light guide for a remote visualization apparatus.

### DETAILED DESCRIPTION

It may be appreciated that the present disclosure is not limited in its application to the details of construction and the arrangement of components set forth in the following description or illustrated in the drawings. The invention(s) herein may be capable of other embodiments and of being practiced or being carried out in various ways. Also, it may be appreciated that the phraseology and terminology used herein is for the purpose of description and should not be regarded as limiting as such may be understood by one of skill in the art.

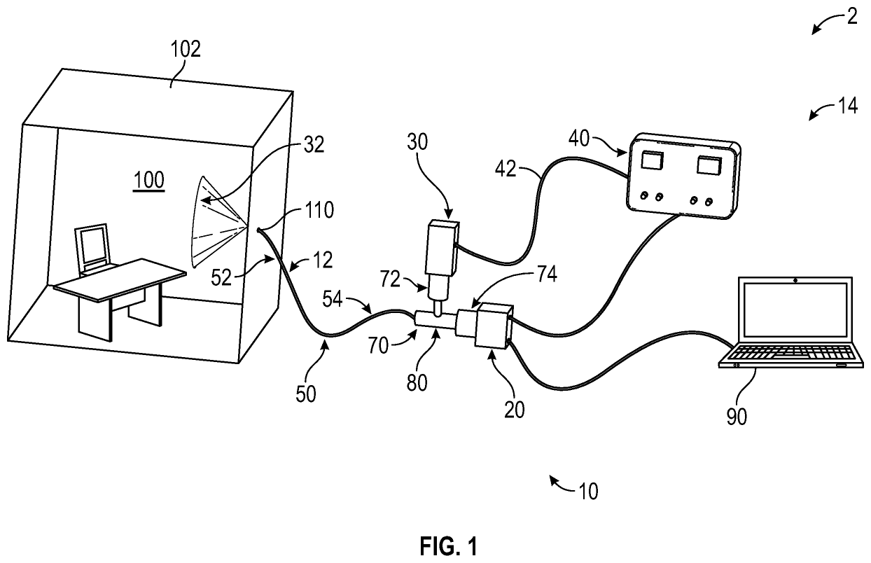

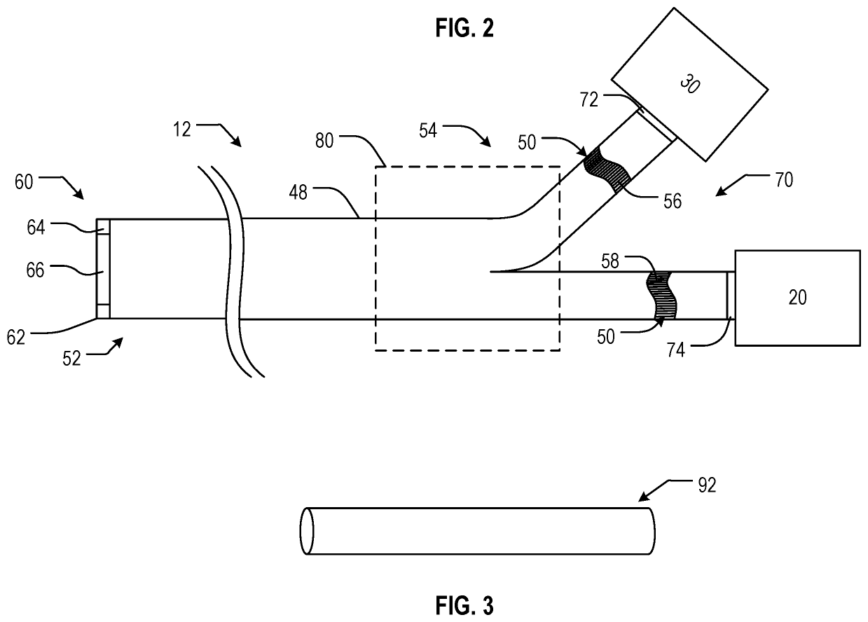

Referring now to FIGS. 1-2, there is shown a remote 3D measurement and visualization LIDAR apparatus 2, particularly comprising a borescope 10. The LIDAR apparatus 2, borescope 10 and accompanying methods of use thereof may provide a solution for remotely measuring distance/range/depth of a target volume 100, particularly within, inside, defined by or otherwise formed by a structure 102, through a small, confined, access point 110, particularly by combining the imaging capabilities of an elongated light and image transmission shaft 12, which may comprise a bundle of optical fibers 50 (as shown in FIG. 2 where the outer sheath 48 of the shaft 12 has been removed), with a (TOF) solid-state camera 20 and an illumination source 30. The remote measurement may then be used to generate a contour (i.e. topographical) map/survey, particularly in a form of a digital (visual), three-dimensional, spatial representation of the target volume 100 with the objects therein.

The structure 102, which may be any man-made structure (e.g. building, machine or other device), natural structure (e.g. cave) or a combination thereof. Structure 102 may include an enclosing structure, particularly a substantially enclosed structure such that the area of all openings into the target volume 100 is 25% or less of the area of the structure defining the target volume 100). The access point 110 may be an opening in the structure 102, such as an opening in floor, roof or wall of the structure 102, an opening beneath a door or window of the structure 102, an opening provided by a ventilation passage of the structure 102). The opening may have an exemplary area of 100 sq·cm. (square centimeters) or less (e.g. 0.01 sq·cm. to 100 sq·cm.; 0.01 sq·cm. to 50 sq·cm.; 0.01 sq·cm. to 25 sq·cm.; 0.01 sq·cm. to 10 sq·cm; 0.01 sq·cm. to 5 sq·cm.)

As shown, borescope 10 may comprise the light and image transmission shaft 12 and a proximal control unit 14. The camera 20 may be provided as part of the borescope 10 (e.g. control unit 14) or otherwise part of the LIDAR apparatus 2. As set forth above, camera 20 may more particularly be a solid-state camera. A solid state camera may be understood to use a solid-state (digital) image sensor. The digital image sensor is an image sensing device that detects (senses) incoming light (photons), corresponding to a target volume 100 (e.g. optical image) via the field of view, and converts the light into electrical (electronic digital) signals.

In general terms, the digital image sensor is an integrated circuit chip which has an array of light sensitive components on a surface, which may be the image plane or the focal plane. The array is formed by individual photosensitive sensor elements. Each photosensitive sensor element converts light detected thereby to an electrical signal. The full set of electrical signals are then converted into an image by an on-board processor or computer processor (i.e. integrated with the chip).

More specifically, the digital image sensor detects the light, converts the light into electrical signals and then transmits the electrical signals to the computer processor, which transforms the electronic signals into a two-dimensional (2D) or three-dimensional (3D) digital representation of the target volume 100 (e.g. a digital image that can be viewed on an image screen, analyzed, or stored).

As known in the art, the image sensor may more particularly perform photoelectric conversion (i.e. convert photons into electrons, with the number of electrons being proportional to the intensity of the light); charge accumulation (i.e. collect generated charge as signal charge); transfer signal (i.e. move signal charge to detecting node); signal detection (i.e. convert signal charge into electrical signal (voltage)); and analog to digital conversion (i.e. convert voltage into digital value).

More particularly, the image sensor may be an active-pixel sensor (APS), in which the individual photosensitive sensor elements comprises a plurality of pixel sensor unit cells, in which each pixel sensor unit cell has a photodetector, e.g. a pinned photodiode and one or more active transistors. An exemplary active-pixel sensor may be a metal-oxide semiconductor active-pixel sensor (MOS APS), which uses metal-oxide semiconductor field-effect transistors (MOSFETs) as amplifiers. Even more particularly, the active-pixel sensor may be a complementary metal-oxide semiconductor active-pixel sensor (CMOS APS). The photodiode may be an avalanche photodiode (APD), such as a Geiger-mode avalanche photodiode (G-APD), and may be particularly based on the indium-gallium-arsenide-phosphide (InGaAsP) material system.

In addition to comprising a photodiode, each pixel sensor unit cell may comprise a micro lens which guides light into the photodiode. Thus, it may be understood that each pixel sensor unit cell may have a photodiode and a micro lens in one-to-one relationship.

The plurality of pixel sensor unit cells, each of which may simply be referred to as a pixel (short for picture element), are arranged in an array of horizontal rows and vertical columns. Thus, the pixels may be referred to as a pixel array, the micro lenses may be referred to as a micro lens array and the photodiodes may be referred to as a photodiode array. Furthermore, it should be understood that the number of pixels will define the camera resolution.

The image sensor may be a visible light sensor, or an infrared light sensor. The visible light sensor may be either a mono sensor (to produce a monochrome image) or a color sensor (to produce a color image). If the image sensor is a color image sensor, each pixel will further comprise a color filter disposed between the micro lens and photodiode, respectively, which may be referred to as a color filer array.

In order to generate an array of depth measurements, the solid-state camera 20 may more particularly be a time-of-flight (TOF) depth camera 20. With a TOF depth camera 20, rather than measuring ambient light, the TOF depth camera 20 measures reflected light of the illumination source 30, which also may be referred to as a light source emitter, which is reflected as discussed in greater detail below. Incident light 32 coming from the illumination source 30 is diverged such that target volume 100 is illuminated, and the reflected light of the illumination source 30 is imaged onto a two-dimensional array of photodetectors. In making reference to a TOF depth camera 20, it should be understood that such is not a range scanner (e.g. rotating mirror), and hence the TOF depth camera 20 may be considered to be a scannerless device.

TOF measurement may be performed a few different ways, depending on the TOF depth camera 20. Depending on how TOF measurement is performed, the TOF depth camera 20 may further be referred to as a pulsed-light (or Direct Time-of-Flight) camera, or a continuous-wave modulated light camera. With a pulsed-light camera, the illumination source 30 may emit pulsed laser light, and differences in the directly measured return times and wavelengths of the laser light to the image sensor may then be used to provide a topographical survey/map of the target volume 100. Alternatively, with a continuous-wave modulated light camera, a phase difference between the emitted and received laser light signals is measured to provide an indirect measurement of travel time. Another TOF measurement technique is referred to as range-gating and uses a shutter (either mechanical or electronic) that opens briefly in synchronization with the outgoing light pulses. Only a portion of the reflected light pulse is collected during the interval the shutter is open and its intensity provides an indirect measurement of distance.

Accordingly, with a pulsed-light camera, the image sensor may be referred to as a pulsed light sensor, or more particularly a pulsed laser light sensor, which directly measures the round-trip time of a light pulse (e.g. a few nanoseconds). Once the pulsed light is reflected on an object, the light pulses are detected by the array of photodiodes that are combined with time-to-digital converters (TDCs) or with time-to-amplitude circuitry. The pulsed light photodetectors may be single photon avalanche diodes. With a 3D flash LIDAR TOF depth camera, the illumination source 30 may be provided from a single laser to illuminate the target volume 100. A 1-D or 2-D array of photodetectors is then used to obtain a depth image.

With a continuous-wave modulated light camera, the image sensor may be referred to as a continuous-wave modulation sensor, which measures the phase differences, particularly between an emitted continuous sinusoidal light-wave signal and the backscattered signals received by each photodetector. The phase difference is then correlated related to distance. With a range-gated camera, the image sensor may be referred to as a range-gated sensor, which measures the intensity of the reflected light pulse over an interval of time shorter than the duration of the light pulse. The intensity of the pulse on a pixel is used to determine the distance to that point.

As set forth above, the borescope 10 further comprises an illumination source 30, particularly a laser which emits laser light. As with the TOF depth camera 20, the illumination source 30 may be provided as part of the borescope 10 (e.g. control unit 14) or otherwise part of the LIDAR apparatus 2. All of the solid-state LIDAR techniques for use with the present disclosure require a high-speed illumination source 30, with an irradiance in the target volume sufficient to overcome the background light, such as a laser or LED. The rise time of the light source may need to be as short as a few nanoseconds for a pulsed light sensor but could be as long as a hundred nanoseconds for a continuous wave modulated sensor.

Depending on the LIDAR technique, the incident light 32 may be amplitude modulated or one or more pulses. In either case, the modulation frequency must be high speed (tens of megahertz) or the pulses must be of very short duration (usually less than 10 nanoseconds).

High intensity is needed to provide a sufficiently strong reflection from surfaces of the target volume 100 for the TOF depth camera 20 to obtain a signal strong enough to overcome the ambient background light. Solid state illumination sources, such as a laser and some LEDs can provide a high enough intensity and fast enough modulation to meet the requirements for use with a solid-state, TOF depth camera 20.

The intensity for the illumination source 30 for the LIDAR apparatus 2/borescope 10 of the present disclosure is greater than those which may be employed for other LIDAR applications, in part to offset the inefficiencies associated with the optical fiber bundle 50 but also due to the need to spread the light over a large area that covers the image sensor field of view.

FIG. 1 shows illumination source 30 as a diode laser, which is the most common type of laser capable of high-speed modulation, but other types of lasers may also be employed. Although near-infrared is the most common wavelength used with TOF depth camera 20, any wavelength within the sensitivity range of the TOF depth camera 20 and the transmission band of the optical fiber bundle 50 of the LIDAR apparatus 2/borescope 10 can be employed. Illumination source 30 may be operatively coupled to a radio-frequency (RF) modulator 40 via a cable 42. Alternatively, the radio-frequency (RF) modulator 40 may be provided as part of the borescope 10 (e.g. control unit 14).

As set forth above, the LIDAR apparatus 2/borescope 10 further comprises an optical fiber bundle 50. The optical fiber bundle 50 uses an array of fibers arranged coherently, so that their relative positions remain fixed from end to end of the optical fiber bundle 50. The number of fibers determines the spatial resolution of the apparatus and can range from 10,000 fibers to 1,000,000 fibers. Exemplary resolutions may include 320×240, 640×480 and 1280×720. The optical fiber bundle 50 is flexible and may have a length in a range of 1 to 3 meters. Given the flexibility, the optical fiber bundle 50 may be used with a flexible borescope, however such flexibility does not preclude use in a rigid borescope, which commonly employ either a rod lens or a set of relay lenses instead of optical fibers.

The optical fiber bundle 50 may be operatively coupled between a distal optic 60 and a proximal optic 70 of the borescope 10. As shown, the distal optic 60 forms a distal end 62 of the borescope 10/shaft 12, and is disposed adjacent a distal end region 52 of the optical fiber bundle 50, particularly to illuminate and image the target volume 100 via the field of view. Proximal optic 70 is disposed adjacent a proximal end region 54 of the optical fiber bundle 50, particularly to operatively couple the illumination source 30 and the TOF depth camera 20 to the optical fiber bundle 50, and electronics to synchronize and control TOF depth camera 20 and the illumination source 30.

More particularly, the proximal optic 70 may comprise an illumination source (fiber) coupling lens 72 which operatively couples the illumination source 30 to an illumination fiber sub-group 56 of the optical fiber bundle 50, and a camera coupling (imaging) lens 74 which operatively couples the TOF depth camera 20 to an image fiber sub-group 58 of the optical fiber bundle 50.

As shown, the illumination source (fiber) coupling lens 72 and the camera coupling lens 74 are operatively coupled to the respective illumination fiber sub-group 56 and the image fiber sub-group 58, respectively, via an optical fiber bundle interface 80, which joins the illumination fiber sub-group 56 and the image fiber sub-group 58 into the optical fiber bundle 50 as such extends distally.

As shown, the optical fiber bundle interface 80 is disposed adjacent the proximal end region 54 of the optical fiber bundle 50. Also as shown, the illumination source (fiber) coupling lens 72 is disposed between the illumination source 30 and the optical fiber bundle interface 80. Similarly, the camera coupling (imaging) lens 74 is disposed between the TOF depth camera 20 and the optical fiber bundle interface 80.

As may be understood from the foregoing arrangement, the incident light 32 from the illumination source 30 is directed to illumination source (fiber) coupling lens 72, which directs the incident light 32 into the proximal ends of the illumination fiber sub-group of the optical fiber bundle 50. Illumination source (fiber) coupling lens 72 is used to efficiently couple the maximum amount of light from the illumination source 30 into the illumination fiber sub-group of the optical fiber bundle 50.

The incident light 32 travels through the fibers of the illumination fiber sub-group 56 of the optical fiber bundle 50 to the distal end of the fibers, where it exits the fibers at the distal optic 60. After being reflected after contacting surfaces in the target volume 100, the reflected light (from the illumination source 30) enters the distal ends of the optical fibers of the image fiber sub-group 58 of the optical fiber bundle 50 through the distal optic 60, which may comprise a small imaging lens 66 (such those used with cameras) which collects light from the target volume 100 and focuses it onto the image fiber sub-group 58 of the optical fiber bundle 50 for transmission. The reflected light then travels proximally to the imaging lens 74 and thereafter to the image sensor of the TOF depth camera 20. The imaging lens 74 images the proximal end of the image fiber sub-group 58 of the optical fiber bundle 50 onto the image plane of the TOF depth camera 20.

It should be understood that, with the optical fiber bundle 50, the incident light 32 from the illumination source 30 is transmitted out through the fibers of the illumination fiber sub-group 56 and thereafter reflected back through the image fiber sub-group 58 (as reflected light from the illumination source 30), and that the illumination fiber sub-group 56 and the image fiber sub-group 58 separate at the optical fiber bundle interface 80 so that the incident light 32 does not directly (i.e. without reflection) reach the TOF depth camera 20. More particularly, the incident light output of the illumination fiber sub-group is not through the imaging lens of the distal optic 60, to avoid back-reflections to the TOF camera 20.

Each optical fiber of the image fiber sub-group 58 of the optical fiber bundle 50 is coupled to a particular pixel of the pixel array of the TOF depth camera 20 in a one-to-one relationship, and the fibers are arranged coherently, so that their relative positions remain fixed from the proximal end/TOF camera 20 to the distal end.

Other electronics may be used to control the TOF camera 20 and illumination source 30, particularly to synchronize the laser modulation or pulses with the camera's frame acquisition. While FIG. 1 shows an RF modulator 40, which would be used for a phase-shift detection technique, but a pulse generator would be used with a direct TOF approach. A constant current controller and thermoelectric cooling controller may also be required to properly drive the illumination source 30. A separate computer 90 (e.g. laptop) can be used for data collection from the TOF depth camera 20, but integrated data collection electronics may also be employed.

The elongated shaft 12 of the borescope 10, which comprises the distal end region 52 of the optical fiber bundle 50 and the distal optic 60, has a diameter which may be sized for the application and/or the access point. For example, for small inspection applications and/or small access points and/or where detection of the boroscope is undesirable (e.g. by an adversary or otherwise), the diameter may be 8 mm or less (e.g. 1 mm to 8 mm) and more particularly 6 mm or less (e.g. 1 mm to 6 mm), In other applications where the size of the access point may be larger and/or detection of the boroscope is not a concern, the diameter may be larger, e.g. 9 mm to 25 mm to allow more light to be collected. Thus, it should be understood that the diameter may be in a range of 1 mm to 25 mm. The optical fiber bundle 50 is flexible. One illumination configuration arranges the illumination fiber sub-group 56 in an annular ring 64 around the perimeter of the distal end to evenly spread the incident light. The center of the annual ring of illumination fibers is occupied by the image fiber subgroup 58. The solid-state TOF depth camera 20 uses a phase detection approach, as this is lower in cost and provides good range and resolution while not having the strict short pulse requirements of the direct TOF approach. A near-infrared diode laser provides a low cost compact illumination source 30 that best matches the sensitivity range of the TOF depth camera 20.

Referring to FIG. 3, in another embodiment, for a rigid borescope, at least one of the illumination fiber sub-group of the optical fiber bundle 50 and the reflection fiber sub-group of the optical fiber bundle 50 are replaced with a rigid (glass or plastic) tubular light guide 92, which may comprise one or more rod lenses and/or relay lenses, respectively. The rigid borescope may have a length of 0.25 meters to 1 meter.

The TOF camera pixels output amplitude and phase information that the camera uses to generate a distance measurement for each pixel. The intensity and distance information is sent to a processor or computer 90 for visualization and further processing. The computer or processor 90 can use the distance information for each pixel and the field of view of the camera to compute a 3D point cloud of the target volume 100 allowing the position of objects within it to be determined.

While a preferred embodiment of the present invention(s) has been described, it should be understood that various changes, adaptations and modifications can be made therein without departing from the spirit of the invention(s) and the scope of the appended claims. The scope of the invention(s) should, therefore, be determined not with reference to the above description, but instead should be determined with reference to the appended claims along with their full scope of equivalents. Furthermore, it should be understood that the appended claims do not necessarily comprise the broadest scope of the invention(s) which the applicant is entitled to claim, or the only manner(s) in which the invention(s) may be claimed, or that all recited features are necessary.

### LIST OF REFERENCE CHARACTERS

2 remote visualization LIDAR apparatus
10 borescope
12 elongated (light and image transmission) shaft
14 proximal control unit
20 (TOF) depth camera
30 illumination source
32 incident light
40 radio-frequency modulator and laser controller
42 laser controller cable
48 sheath of shaft
50 optical fiber bundle
52 distal end region of the optical fiber bundle
54 proximal end region of the optical fiber bundle
56 illumination fiber sub-group of optical bundle (illumination transmission portion of shaft)
58 image fiber sub-group of optical bundle (image transmission portion of shaft)
60 distal optic
62 distal end of borescope/shaft
64 annular ring
66 imaging lens
70 proximal optic
72 illumination source (fiber) coupling lens
74 camera coupling (imaging) lens
80 optical fiber bundle interface
90 processor or computer
92 rigid tubular light guide
100 target volume
102 structure
110 confined space access point

What is claimed is:

1. A remote 3D measurement and visualization apparatus comprising:
a borescope, comprising a light and image transmission shaft;
a solid state, time-of-flight depth camera having a plurality of pixels;
an illumination source to emit illumination source light;
wherein the illumination source light is modulated or pulsed to generate a time-varying intensity suitable for the time-of-flight depth camera to measure distances within a target volume;
wherein the shaft has a diameter suitable to enter the target volume through an access point;
wherein the shaft has an illumination transmission portion and an image transmission portion;
wherein the illumination transmission portion of the shaft is operatively arranged to transmit the illumination source light from the illumination source distally along the shaft and emit the illumination source light from a distal end of the borescope to illuminate the target volume;
wherein the image transmission portion of the shaft is operatively arranged to receive reflected illumination source light from the target volume and transmit the reflected illumination source light proximally along the shaft to the time-of-flight depth camera; and
wherein the time-of-flight depth camera is operatively arranged to transmit intensity and phase data of the reflected illumination source light from the pixels to a processor and/or a computer to generate a digital, three-dimensional, spatial representation of the target volume.

2. The remote 3D measurement and visualization apparatus according to claim 1, wherein the borescope comprises a proximal control unit coupled to the shaft; and
wherein the proximal control unit comprises the time-of-flight depth camera.

3. The remote 3D measurement and visualization apparatus according to claim 1, wherein the borescope comprises a proximal control unit coupled to the shaft; and
wherein the proximal control unit comprises the illumination source.

4. The remote 3D measurement and visualization apparatus according to claim 1, wherein a camera coupling lens is disposed between a proximal end of the image transmission portion of the shaft and the time-of-flight depth camera; and
wherein the camera coupling lens images the reflected illumination source light transmitted from the image transmission portion of the shaft onto an image plane of the time-of-flight depth camera.

5. The remote 3D measurement and visualization apparatus according to claim 1, wherein an illumination source coupling lens is disposed between a proximal end of the illumination transmission portion of the shaft and the illumination source; and
wherein the illumination source coupling lens operatively couples the illumination source light from the illumination source to the illumination transmission portion of the shaft.

6. The remote 3D measurement and visualization apparatus according to claim 1, wherein the shaft is a flexible shaft;
wherein the illumination transmission portion of the shaft is provided by a first group of optical fibers; and
wherein the image transmission portion of the shaft is provided by a second group of optical fibers.

7. The remote 3D measurement and visualization apparatus according to claim 1, wherein the shaft is a rigid shaft; and
wherein at least one of the illumination transmission portion of the shaft and the image transmission portion of the shaft is provided by a rigid tubular light guide, respectively.

8. The remote 3D measurement and visualization apparatus according to claim 7, wherein the rigid tubular light guide comprises at least one rod lens.

9. The remote 3D measurement and visualization apparatus according to claim 7, wherein the rigid tubular light guide comprises at least one relay lens.

10. The remote 3D measurement and visualization apparatus according to claim 1, wherein the illumination source comprises a laser.

11. The remote 3D measurement and visualization apparatus according to claim 10, wherein the laser is a diode laser.

12. The remote 3D measurement and visualization apparatus according to claim 1, wherein the illumination source comprises one or more light emitting diodes.

13. The remote 3D measurement and visualization apparatus according to claim 1, wherein the image transmission portion of the shaft is provided by a group of optical fibers; and
wherein the group of optical fibers are arranged in a coherent array so that their relative positions remain fixed from one end to an opposing end of the group.

14. The remote 3D measurement and visualization apparatus according to claim 1, wherein the time-of-flight depth camera comprises an image or a focal plane having an array of the pixels;
wherein the image transmission portion of the shaft is provided by a group of optical fibers;
wherein each pixel of the array of the pixels is operatively coupled to one of the optical fibers in a one-to-one relationship; and
wherein a position of each of the optical fibers remains fixed relative to one another from a proximal end of each fiber to a distal end of each fiber, respectively.

15. The remote 3D measurement and visualization apparatus according to claim 1, wherein the diameter of the shaft is 1 mm to 25 mm.

16. The remote 3D measurement and visualization apparatus according to claim 1, wherein the diameter of the shaft is 8 mm or less.

17. A method of operating a remote 3D measurement and visualization apparatus comprising:
obtaining the remote 3D measurement and visualization apparatus, wherein the remote visualization apparatus comprises
a borescope, comprising a light and image transmission shaft;
a solid state, time-of-flight depth camera having a plurality of pixels;
an illumination source to emit illumination source light;
wherein the illumination source light is modulated or pulsed to generate a time-varying intensity suitable for the time-of-flight depth camera to measure distances within a target volume;
wherein the shaft has a diameter suitable to enter the target volume through an access point;
wherein the shaft has an illumination transmission portion and an image transmission portion;
wherein the illumination transmission portion of the shaft is operatively arranged to transmit the illumination source light from the illumination source distally along the shaft and emit the illumination source light from a distal end of the borescope to illuminate a target volume;
wherein the image transmission portion of the shaft is operatively arranged to receive reflected illumination source light from the target volume and transmit the reflected illumination source light proximally along the shaft to the time-of-flight depth camera; and
wherein the time-of-flight depth camera is operatively arranged to transmit intensity and phase data of the reflected illumination source light from the pixels to a processor and/or a computer to generate a digital, three-dimensional, spatial representation of the target volume;
inserting the shaft of the borescope through an access point of a structure; and
operating the remote visualization apparatus, including the borescope, to generate the digital, three-dimensional, spatial representation of a target volume within the structure.

18. The method of operating a remote visualization apparatus 15 wherein operating the remote visualization apparatus is performed as part of an inspection of the target volume.
